(19) United States
(12) Patent Application Publication
(10) Pub. No.: US 2022/0237388 A1
(43) Pub. Date: Jul. 28, 2022

(54) METHOD AND APPARATUS FOR GENERATING TABLE DESCRIPTION TEXT, DEVICE AND STORAGE MEDIUM

(71) Applicant: Beijing Baidu Netcom Science Technology Co., Ltd., Beijing (CN)

(72) Inventors: Xinjiang LU, Beijing (CN); Yanyan LI, Beijing (CN); Jingbo ZHOU, Beijing (CN); Dejing DOU, Beijing (CN)

(21) Appl. No.: 17/714,891

(22) Filed: Apr. 6, 2022

(30) Foreign Application Priority Data
Sep. 30, 2021 (CN) 202111164342.3

(51) Int. Cl. G06F 40/40; G06F 40/30; G06F 40/177; G06F 40/20

(52) U.S. Cl. CPC G06F 40/40; G06F 40/20; G06F 40/177; G06F 40/30

(57) ABSTRACT

A method and apparatus for generating a table description text, a device, and a storage medium are provided. An implementation of the method includes: acquiring a to-be-described table, and analyzing the to-be-described table to obtain a set of metalanguage of the to-be-described table, and finally generating a description text of the to-be-described table based on the metalanguage in the set of metalanguage.

### CROSS-REFERENCE TO RELATED APPLICATIONS

This application claims priority to Chinese Patent Application No. 202111164342.3, filed with the China National Intellectual Property Administration (CNIPA) on Sep. 30, 2021, the content of which is incorporated herein by reference in its entirety.

### TECHNICAL FIELD

The present disclosure relates to the technical field of data processing, in particular to the technical field of artificial intelligence.

### BACKGROUND

At present, numerical tables (such as reports, annual/quarterly statistics) are often used in daily work. In order to understand data in the tables, it is usually necessary to make table description texts corresponding to the table data, and interpret the data in the tables through the table description texts.

However, when preparing the table description texts corresponding to the table data, in the prior art, usually, professional data analysts analyze the table data and then write the corresponding table description texts, and the labor cost is often high.

### SUMMARY

Embodiments of the present disclosure provides a method and apparatus for generating a table description text, a device and a storage medium.

In a first aspect, some embodiments of the present disclosure provide a method for generating a table description text, the method includes: acquiring a to-be-described table; analyzing the to-be-described table to obtain a set of metalanguage of the to-be-described table, where the set of metalanguage comprises at least one metalanguage, and the metalanguage is a word and sentence determined according to a cell in the to-be-described table; generating a description text of the to-be-described table based on the metalanguage in the set of metalanguage.

In another aspect, some embodiments of the present disclosure provide an apparatus for generating a table description text, the apparatus includes: a table acquiring module, configured to acquire a to-be-described table; a table analyzing module, configured to analyze the to-be-described table to obtain a set of metalanguage of the to-be-described table, where the set of metalanguage comprises at least one metalanguage, and the metalanguage is a word and sentence determined according to a cell in the to-be-described table; and a text generating module, configured to generate a description text of the to-be-described table based on the metalanguage in the set of metalanguage.

In another aspect, some embodiments of the present disclosure provide an electronic device, the device includes: at least one processor; and a memory communicatively connected to the at least one processor; where the memory stores instructions executable by the at least one processor, and the instructions, when executed by the at least one processor, cause the at least one processor to perform the method according to the first aspect.

In another aspect, some embodiments of the present disclosure provide a non-transitory computer readable storage medium storing computer instructions, where, the computer instructions, when executed by a computer, cause the computer to perform the method according to the first aspect.

In yet another aspect, some embodiments of the present disclosure provide a computer program product, the computer program product comprises a computer program, the computer program, when executed by a processor, cause the processor to implement the method according to the first aspect.

It should be understood that the content described in this section is not intended to identify key or important features of embodiments of the present disclosure, nor is it intended to limit the scope of the present disclosure. Other features of the present disclosure will become readily understood from the following specification.

### BRIEF DESCRIPTION OF THE DRAWINGS

The accompanying drawings are used for better understanding of the present solution, and do not constitute a limitation to the present disclosure. In which:

FIG. 1 is a schematic diagram according to a first embodiment of the present disclosure;

FIG. 2 is a schematic flowchart of a pre-trained extractor that is capable of implementing embodiments of the present disclosure;

FIG. 3 is a schematic diagram according to a second embodiment of the present disclosure;

FIG. 4 is a schematic diagram according to a third embodiment of the present disclosure;

FIG. 5 is a schematic diagram according to a fourth embodiment of the present disclosure;

FIG. 6 is a schematic diagram according to a fifth embodiment of the present disclosure;

FIG. 7 is a schematic diagram according to a sixth embodiment of the present disclosure;

FIG. 8 is a schematic diagram according to a seventh embodiment of the present disclosure;

FIG. 9 is a schematic diagram according to an eighth embodiment of the present disclosure;

FIG. 10 is a schematic diagram according to a tenth embodiment of the present disclosure;

FIG. 11 is a schematic diagram according to an eleventh embodiment of the present disclosure;

FIG. 12 is a schematic diagram according to a twelfth embodiment of the present disclosure;

FIG. 13 is a schematic diagram according to a thirteenth embodiment of the present disclosure;

FIG. 14 is a schematic diagram according to a fourteenth embodiment of the present disclosure;

FIG. 15 is a schematic diagram according to a fifteenth embodiment of the present disclosure; and

FIG. 16 is a block diagram of an electronic device used to implement the method for generating a table description text of the embodiments of the present disclosure.

### DETAILED DESCRIPTION OF EMBODIMENTS

Example embodiments of the present disclosure are described below with reference to the accompanying drawings, where various details of embodiments of the present disclosure are included to facilitate understanding, and should be considered merely as examples. Therefore, those of ordinary skills in the art should realize that various changes and modifications may be made to embodiments described herein without departing from the scope and spirit of the present disclosure. Similarly, for clearness and conciseness, descriptions of well-known functions and structures are omitted in the following description.

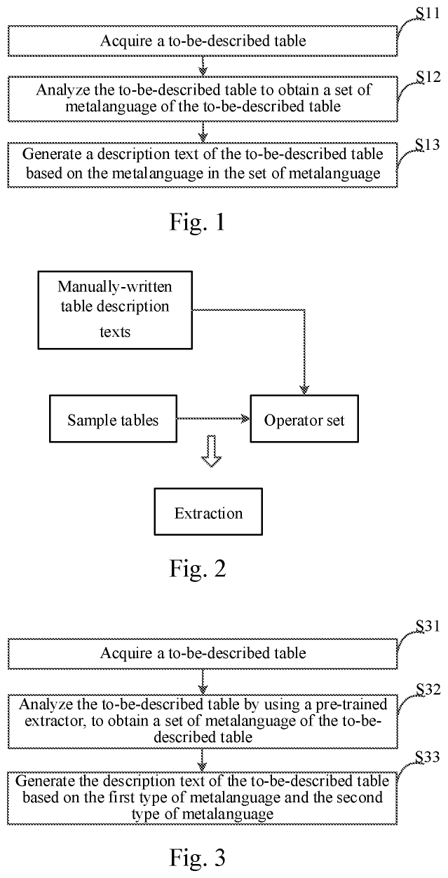

In one aspect of the present disclosure, a method for generating a table description text is provided, referring to FIG. 1, including:

Step S11, acquiring a to-be-described table.

In an embodiment of the present disclosure, the to-be-described table may be a table of any type. In an example, the types of tables may be sorted according to application scenarios of the tables, such as data tables of urban statistics type, data tables of enterprise financial report type, and/or data tables of engineering survey type. In an example, a table may have a table title, a header, a table body, a table note, etc.

The method for generating a table description text may be applied to an intelligent terminal, and may be implemented through the intelligent terminal. In particular, the intelligent terminal may be a computer, a smartphone, a server, and the like.

Step S12, analyzing the to-be-described table, to obtain a set of metalanguage of the to-be-described table.

In an example of the present disclosure, the to-be-described table may be analyzed by using a pre-trained extractor. The pre-trained extractor may be obtained by training based on a plurality of sample tables and respective manually-written description texts of the sample tables, and then the extractor obtained by training is used to analyze the to-be-described table. Referring to FIG. 2, an operator set may be trained by using a plurality of manually-written table description texts through supervised learning to obtain a pre-trained extractor, and then the to-be-described table is analyzed by the pre-trained extractor to obtain the set of metalanguage of the to-be-described table. In particular, the training of the extractor may include: inputting a plurality of sample tables and table description texts corresponding to the sample tables into a to-be-trained extractor; analyzing each sample table by the to-be-trained extractor, to obtain a set of predicted metalanguage that may be used during generating the table description text of the each sample table; analyzing each table description text corresponding to each sample table to obtain a set of metalanguage corresponding to the table description text; comparing the set of predicted metalanguage corresponding to a sample table with the set of metalanguage corresponding to the sample table, and calculating to obtain a current loss of the to-be-trained extractor; adjusting parameters of the to-be-trained extractor based on the current loss, and returning to the step “analyzing the sample tables by the to-be-trained extractor, to obtain a set of predicted metalanguage that the sample tables may use when generating the table description texts”, and continuing executing until the current loss is less than a preset threshold, to obtain the pre-trained extractor.

In an example, the extractor in embodiments of the present disclosure is obtained by training in advance through a plurality of sample tables and respective manually-written sets of sample metalanguage of the sample tables. Alternatively, the training of the pre-trained extractor may include: acquiring sample tables and a set of sample metalanguage of each sample table; and training an extractor by using the sample tables and the set of sample metalanguage of each sample table to obtain the pre-trained extractor. In particular, training an extractor by using the sample tables and the set of sample metalanguage of each sample table to obtain the pre-trained extractor, may include: inputting a plurality of sample tables and sets of sample metalanguage corresponding to the sample tables into a to-be-trained extractor; analyzing each sample table by using the to-be-trained extractor, to obtain a set of predicted metalanguage which may be used during generating a table description text of the sample table; comparing the set of predicted metalanguage corresponding to a sample table with the set of sample metalanguage corresponding to the sample table, and calculating to obtain a current loss of the to-be-trained extractor; adjusting parameters of the to-be-trained extractor based on the current loss, and returning to the step “analyzing the sample tables by the to-be-trained extractor, to obtain sets of predicted metalanguage that the sample tables may use when generating the table description texts”, and continuing executing until the current loss is less than a preset threshold, to obtain the pre-trained extractor.

In an embodiment of the present disclosure, the set of metalanguage includes at least one piece of metalanguage, and the metalanguage is a word and sentence determined according to a cell in the to-be-described table. By analyzing the to-be-described table by the pre-trained extractor, the metalanguage corresponding to data contained in the table may be extracted. For example, the table is:

| City | Time | Number of Service Staff |
|---|---|---|
| a | October 2020 | 2,100 |
| a | October 2021 | 1,600 |
| c | October 2022 | 1,000 |

By analyzing the to-be-described table by the pre-trained extractor, the metalanguage corresponding to the data contained in the table may be extracted as follows: the number of service staff in city a in October 2021 is 2,122; the number of service staff in city a in October 2020 is 1,600; and the number of service staff in city c in October 2020 is 1,000.

Step S13, generating a description text of the to-be-described table based on the metalanguage in the set of metalanguage.

In an example, operations such as arranging, combining, and filtering may be performed on each piece of the metalanguage in the set of metalanguage according to semantics, to generate the description text of the to-be-described table. In an example, the set of metalanguage may be input into a pre-trained text generation model, so as to obtain the description text of the to-be-described table.

For example, by analyzing the to-be-described table by the extractor, the obtained set of metalanguage of the to-be-described table is: the number of service staff in city a in October 2021 is 2,122; the number of service staff in city a in October 2020 is 1,600; and the number of service staff in city c in October 2020 is 1,000. By arranging and combining the extracted set of metalanguage, the description text of the to-be-described table may be generated: the number of service staff in city a in October 2021 is 2,122, the number of service staff in city a in October 2020 is 1,600, the number of service staff in city c in October 2020 is 1,000. It is also possible to filter the set of metalanguage, remove some of the metalanguage in the set of metalanguage, and then perform arranging and combining. For example, when the current table description text is a description text for city a, the metalanguage corresponding to city c may be removed, and the description text of the to-be-described table is generated as: the number of service staff in city a in October 2021 is 2,122, the number of service staff in city a in October 2020 is 1,600. In actual use, in order to make the generated description text of the to-be-described table more suitable for one's reading habits, the order of the words may also be modified and words may be replaced, so that the generated description text of the to-be-described table is closer to natural language. For example, after the modification to the order of the words and word replacement, the description text of the to-be-described table may be generated as: the number of service staff in city a in October this year is 2,122, the number of service staff in city a in October last year is 1,600.

It can be seen that, through the method for generating a table description text, a to-be-described table may be acquired, and by using a pre-trained extractor, the to-be-described table may be analyzed to obtain a set of metalanguage of the to-be-described table, and finally a description text of the to-be-described table may be generated based on the metalanguage in the set of metalanguage. Therefore, automatic generation of the table description text is realized, not only a labor cost may be reduced, but also the time-consuming of generating the table description text may be reduced, and the efficiency of generating the table description text may be improved.

Alternatively, referring to FIG. 3, the set of metalanguage includes a first type of metalanguage and a second type of metalanguage, the first type of metalanguage is a word and sentence representing semantics of the cell in the to-be-described table, and the second type of metalanguage is a word and sentence representing an association relationship between at least two piece of metalanguage of the first type; step S13 of generating a description text of the to-be-described table based on the metalanguage in the set of metalanguage, includes: generating the description text of the to-be-described table based on the first type of metalanguage and the second type of metalanguage. The method described above may include:

Step S31, acquiring a to-be-described table.

Step S32, analyzing the to-be-described table by using a pre-trained extractor to obtain a set of metalanguage of the to-be-described table.

Step S33, generating the description text of the to-be-described table based on the first type of metalanguage and the second type of metalanguage.

The first type of metalanguage represents the semantics of the cell in the to-be-described table. In actual use, the first type of metalanguage is metalanguage obtained by analyzing the to-be-described table and directly extracting the metalanguage based on data in the table. For example, the table contains: city: a, time: October 2021, the number of service staff: 2,122; city: a, time: October 2020, the number of service staff: 1,600. Then the metalanguage of the first type may be directly extracted: the number of service staff in city a in October 2021 is 2,122, the number of service staff in city a in October 2020 is 1,600.

The second type of metalanguage represents the association relationship between at least two pieces of metalanguage of the first type. In actual use, the second type of metalanguage is metalanguage extracted from data calculated from the data in the to-be-described table. For example, it is calculated and obtained that in city a, the number of service staff has increased by 32.625% in October 2021 compared with October 2020, then the metalanguage of the second type extracted by the extractor is: in city a, the number of service staff has increased by 32.625% in October 2021 compared to October 2020.

The description text of the to-be-described table is generated based on the first type of metalanguage and the second type of metalanguage, and the first type of metalanguage and the second type of metalanguage may be sorted, filtered and combined to obtain the description text of the to-be-described table. For example, for the first type of metalanguage: the number of service staff in city a in October 2021 is 2,122; the number of service staff in city a in October 2020 is 1,600, and the second type of metalanguage: in city a, the number of service staff has increased by 32.625% in October 2021 compared to October 2020, the description text of the to-be-described table is generated as: the number of service staff in city a in October 2021 is 2,122, the number of service staff in city a in October 2020 is 1,600, in city a, the number of service staff has increased by 32.625% in October 2021 compared to October 2020.

It can be seen that, through the method of this embodiment of the present disclosure, the to-be-described table may be analyzed to obtain the first type of metalanguage representing the semantics of the cell in the to-be-described table and the second type of metalanguage representing the association relationship between at least two pieces of metalanguage of the first type. Not only can the metalanguage of the data contained in the to-be-described table be extracted, but also the association relationship can be calculated for the data in the to-be-described table, so as to realize interpretation of the association relationship of the data in the to-be-described table.

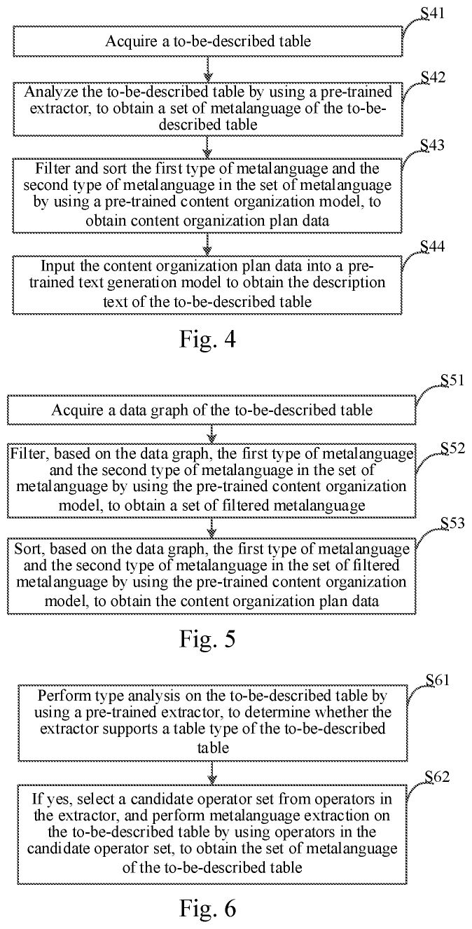

Alternatively, referring to FIG. 4, step S33 of generating the description text of the to-be-described table based on the first type of metalanguage and the second type of metalanguage, includes: filtering and sorting the first type of metalanguage and the second type of metalanguage in the set of metalanguage by using a pre-trained content organization model to obtain content organization plan data; and inputting the content organization plan data into a pre-trained text generation model to obtain the description text of the to-be-described table. The above method includes:

Step S41, acquiring a to-be-described table.

Step S42, analyzing the to-be-described table by using a pre-trained extractor to obtain the set of metalanguage of the to-be-described table.

Step S43, filtering and sorting the first type of metalanguage and the second type of metalanguage in the set of metalanguage by using a pre-trained content organization model to obtain content organization plan data.

Step S44, inputting the content organization plan data into a pre-trained text generation model to obtain the description text of the to-be-described table.

In an example, the pre-trained content organization model may be obtained by training in advance through sets of metalanguage of a plurality of sample tables and manually-written content organization plan data of the sample tables. The first type of metalanguage and the second type of metalanguage in the set of metalanguage are filtered and sorted by using the pre-trained content organization model. For example, the set of metalanguage extracted by the extractor is: the number of service staff in city a in October 2021 is 2,122; the number of service staff in city a in October 2020 is 1,600; and the number of service staff in city c in October 2020 is 1,000, in city a, the number of service staff has increased by 32.625% in October 2021 compared to October 2020. A content organization module may remove the metalanguage corresponding to the city c, and the obtained content organization plan is: the number of service staff in city a in October 2021 is 2,122, the number of service staff in city a in October 2020 is 1,600, in city a, the number of service staff has increased by 32.625% in October 2021 compared to October 2020.

The content organization plan data is input into the pre-trained text generation model to obtain the description text of the to-be-described table. The pre-trained text generation model in embodiments of the present disclosure may be a text generation model provided by a third party, or may be obtained by training through content organization plan data of a plurality of sample tables and manually-written description texts of the sample tables. The text generation model may modify the order of words and replace a word, so that the generated description text of the to-be-described table is closer to natural language. For example, the content organization plan is: the number of service staff in city a in October 2021 is 2,122; the number of service staff in city a in October 2020 is 1,600, in city a, the number of service staff has increased by 32.625% in October 2021 compared to October 2020. By inputting the content organization plan data into the pre-trained text generation model for word order modification and word replacement, the description text of the to-be-described table is obtained as: the number of service staff in city a in October 2020 was 1,600, the number of service staff increased by 32.625% in October this year compared with the same period last year, and the number of service staff in October this year is 2,122.

It can be seen that, through the method of this embodiment of the present disclosure, the pre-trained content organization model may be used to filter and sort the first type of metalanguage and the second type of metalanguage in the set of metalanguage to obtain the content organization plan data; and the content organization plan data is input into the pre-trained text generation model, to obtain the description text of the to-be-described table. Not only can the pre-trained content organization model be used to filter and sort the first type of metalanguage and the second type of metalanguage in the set of metalanguage, but also the order of words can be modified and a word can be replaced by the pre-trained text generation model, so that the generated description text of the to-be-described table meets user requirements, and the generated table description text may also be closer to natural language, which is easy to read.

Alternatively, referring to FIG. 5, step S43 of filtering and sorting the first type of metalanguage and the second type of metalanguage in the set of metalanguage by using a pre-trained content organization model to obtain content organization plan data, includes:

Step S51, acquiring a data graph of the to-be-described table;

Step S52, filtering, based on the data graph, the first type of metalanguage and the second type of metalanguage in the set of metalanguage by using the pre-trained content organization model, to obtain a set of filtered metalanguage; and

Step S53, sorting, based on the data graph, the first type of metalanguage and the second type of metalanguage in the set of filtered metalanguage by using the pre-trained content organization model, to obtain the content organization plan data.

In actual use, there is often a corresponding data graph in the to-be-described table. For example, a histogram, a line chart, or a radar chart, etc. In the process of using the pre-trained content organization model to filter and sort the first type of metalanguage and the second type of metalanguage in the set of metalanguage, the pre-trained content organization model may be used to filter and sort the first type of metalanguage and the second type of metalanguage in the set of metalanguage based on the data graph. For example, the line chart is mainly used to represent growth and decline rates, then, when using the pre-trained content organization model to filter the first type of metalanguage and the second type of metalanguage in the set of metalanguage based on the data graph, metalanguage regarding the growth and decline rates may be preferentially kept; and when using the pre-trained content organization model to sort the first type of metalanguage and the second type of metalanguage in the set of filtered metalanguage based on the data graph, the metalanguage regarding the growth and decline rates may be ranked first. As another example, the histogram is mainly used to represent a difference or differences, then, when using the pre-trained content organization model to filter the first type of metalanguage and the second type of metalanguage in the set of metalanguage based on the data graph, metalanguage corresponding to the difference(s) may be preferentially kept; and when using the pre-trained content organization model to sort the first type of metalanguage and the second type of metalanguage in the set of filtered metalanguage based on the data graph, the metalanguage corresponding to the difference(s) may be ranked first.

It can be seen that, through the method of this embodiment of the present disclosure, the data graph of the to-be-described table may be acquired. By using the pre-trained content organization model, the first type of metalanguage and the second type of metalanguage in the set of metalanguage are filtered based on the data graph, to obtain the set of filtered metalanguage. By using the pre-trained content organization model, the first type of metalanguage and the second type of metalanguage in the set of filtered metalanguage are sorted based on the data graph, to obtain the content organization plan data. The to-be-described table may be interpreted by using latent semantics contained in the data graph.

Alternatively, referring to FIG. 6, step S12 of analyzing the to-be-described table to obtain a set of metalanguage of the to-be-described table, includes:

Step S61, performing type analysis on the to-be-described table by using a pre-trained extractor, to determine whether the pre-trained extractor supports a table type of the to-be-described table; and

Step S62, if yes, selecting a candidate operator set from operators of the extractor, and performing metalanguage extraction on the to-be-described table by using operators in the candidate operator set, to obtain the set of metalanguage of the to-be-described table.

In an embodiment of the present disclosure, the table type may be sorted according to an application scenario of the table, such as data tables of urban statistics type, data tables of enterprise financial report type, or data tables of engineering survey type. The extractor may include a cluster of operators for extracting data in the numerical table. In particular, a corresponding extractor may be trained for each table type in advance. When performing type analysis on the to-be-described table by using a pre-trained extractor to determine whether the extractor supports the table type of the to-be-described table, the table type of the to-be-described table may be acquired, and then it may be determined whether there is an extractor corresponding to the table type, if yes, it indicates that the extractor supports the table type of the to-be-described table. Then, a candidate operator set is selected from the operators in the extractor through the corresponding extractor, and the operators in the candidate operator set are used to perform metalanguage extraction on the to-be-described table.

In an embodiment of the present disclosure, the operator set is a function set. The operator set, which is selected from the operators by the extractor for generating the table description text of the to-be-described table, is referred to as the candidate operator set. For example, the table contains: city: a; time: October 2021; the number of service staff: 2,122; city: a; time: October 2020; the number of service staff: 1,600. Then, the extractor may extract an operator used to calculate the difference, an operator used to calculate the growth rate, and an operator representing current data, so that the metalanguage may be extracted: the number of service staff in city a in October 2021 is 2,122, the number of service staff in city a in October 2020 is 1,600, the metalanguage corresponding to the growth rate operator: in city a, the number of service staff has increased by 32.625% in October 2021 compared to October 2020, and the metalanguage corresponding to the difference operator: in city a, the number of service staff in October 2021 increased by 522 compared to October 2020.

Alternatively, after the performing type analysis on the to-be-described table, to determine whether the extractor supports a table type of the to-be-described table, the method further includes: if not, outputting an error message indicating that the table type of the to-be-described table is not supported. The extractor is pre-trained by using sample tables and sets of sample metalanguage of the sample tables, so that the pre-trained extractor is used to extract the set of metalanguage, and the description text is generated based on the extracted set of metalanguage.

It can be seen that, through the method of this embodiment of the present disclosure, the pre-trained extractor may be used to analyze the type of the to-be-described table to determine whether the extractor supports the table type of the to-be-described table. If yes, a candidate operator set is selected from the operators in the extractor, and the operators in the candidate operator set are used to perform metalanguage extraction on the to-be-described table, to obtain the set of metalanguage of the to-be-described table. The extractor corresponding to the table type predicts and extracts the operators, so that the extracted operators are used to perform metalanguage extraction on the to-be-described table, to obtain the set of metalanguage of the to-be-described table, and the table description text is generated based on the set of metalanguage, improving the accuracy of operator prediction and extraction.

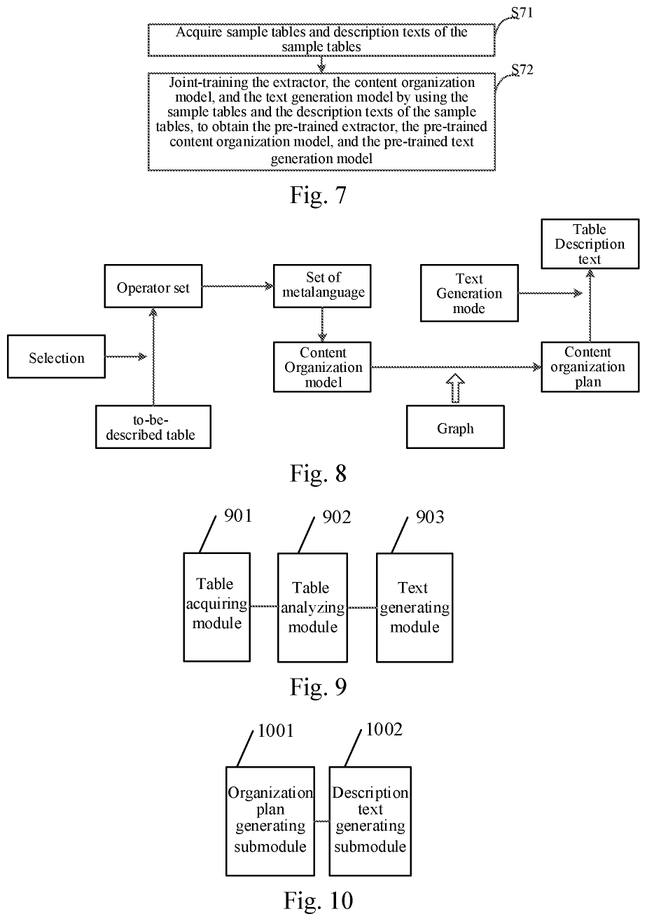

In an embodiment of the present disclosure, an extractor, a content organization model, and a text generation model may be trained individually or jointly; alternatively, referring to FIG. 7, the above method further includes:

Step S71, acquiring sample tables and description texts of the sample tables; and

Step S72, joint-training the extractor, the content organization model, and the text generation model by using the sample tables and the description texts of the sample tables to obtain the pre-trained extractor, the pre-trained content organization model, and the pre-trained text generation model.

In particular, the training process of joint-training the extractor, the content organization model, and the text generation model by using the sample tables and the description texts of the sample tables to obtain the pre-trained extractor, the pre-trained content organization model, and the pre-trained text generation model, may include: inputting a plurality of sample tables and table description texts corresponding to the sample tables into a to-be-trained extractor, a to-be-trained content organization model, and a to-be-trained text generation model; generating a predicted description text corresponding to a sample table through the to-be-trained extractor, the to-be-trained content organization model, and the to-be-trained text generation model; comparing the predicted description text corresponding to the sample table with the description text corresponding to the sample table, and calculating to obtain a current loss; adjusting parameters of the to-be-trained extractor, the to-be-trained content organization model, and the to-be-trained text generation model based on the current loss, and returning to the step “generating a predicted description text corresponding to a sample table through the to-be-trained extractor, the to-be-trained content organization model”, and continuing executing until the current loss is less than a preset threshold, to obtain the pre-trained extractor, the pre-trained content organization model, and the pre-trained text generation model.

It can be seen that, through the method of this embodiment of the present disclosure, the extractor, the content organization model, and the text generation model may be jointly trained by using the sample tables and the description texts of the sample tables to obtain the pre-trained extractor, the pre-trained content organization model, and the pre-trained text generation model, so that a training efficiency may be improved by using the joint training method.

In actual use, referring to FIG. 8, the method for generating a table description text:

1. Through supervised end-to-end learning, by using numerical tables and manually-written table description texts, training to obtain an extractor including a cluster of operators for extracting data in the table;

2. Matching a type of a to-be-described table by using the pre-trained extractor, if the pre-trained extractor does not support the table type, returning an error message indicating that the table type is not supported, and terminating, otherwise, proceeding to the step 3;

3. Inputting the to-be-described table into the pre-trained extractor, identifying a candidate operator set that may be demanded by the to-be-described table, and performing metalanguage extraction on the original table to-be-described based on the candidate operator set, to obtain a candidate metalanguage set;

4. Filtering and sorting the metalanguage through a content organization model, to generate a content organization plan, where a graph style is also considered as a sorting factor during the sorting; and

5. Increasing the diversity of generated text by using a pre-trained text generation model, and finally generating the table description text.

In another aspect of the present disclosure, an apparatus for generating a table description text is provided, referring to FIG. 9, including:

a table acquiring module 901, configured to acquire a to-be-described table;

a table analyzing module 902, configured to analyze the to-be-described table to obtain a set of metalanguage of the to-be-described table, where the set of metalanguage comprises at least one metalanguage, and the metalanguage is a word and sentence determined according to a cell in the to-be-described table; and

a text generating module 903, configured to generate a description text of the to-be-described table based on the metalanguage in the set of metalanguage.

Alternatively, the set of metalanguage includes a first type of metalanguage and a second type of metalanguage, the first type of metalanguage is a word and sentence representing semantics of the cell in the to-be-described table, and the second type of metalanguage is a word and sentence representing an association relationship between at least two pieces of metalanguage of the first type; and

the text generating module 903 is configured to generate the description text of the to-be-described table based on the first type of metalanguage and the second type of metalanguage.

Alternatively, referring to FIG. 10, the text generating module 903 includes:

an organization plan generating submodule 1001, configured to filter and sort the first type of metalanguage and the second type of metalanguage in the set of metalanguage by using a pre-trained content organization model, to obtain content organization plan data; and

a description text generating submodule 1002, configured to input the content organization plan data into a pre-trained text generation model to obtain the description text of the to-be-described table.

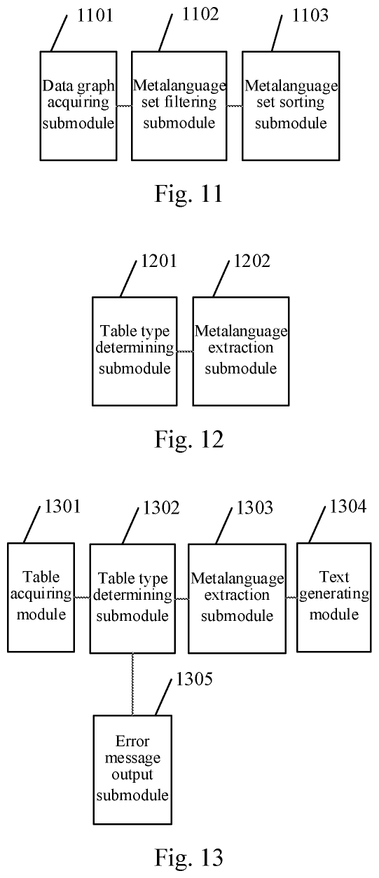

Alternatively, referring to FIG. 11, the organization plan generating submodule 1001 includes:

a data graph acquiring submodule 1101, configured to acquire a data graph of the to-be-described table;

a metalanguage set filtering submodule 1102, configured to filter the first type of metalanguage and the second type of metalanguage in the set of metalanguage by using the pre-trained content organization model, based on the data graph, to obtain a set of filtered metalanguage; and

a metalanguage set sorting submodule 1103, configured to sort, based on the data graph, the first type of metalanguage and the second type of metalanguage in the set of filtered metalanguage by using the pre-trained content organization model, to obtain the content organization plan data.

Alternatively, referring to FIG. 12, the table analyzing module 902 includes:

a table type determining submodule 1201, configured to perform type analysis on the to-be-described table by using a pre-trained extractor, to determine whether the pre-trained extractor supports a table type of the to-be-described table; and

a metalanguage extraction submodule 1202, configured to, if yes, select a candidate operator set from operators of the extractor, and perform metalanguage extraction on the to-be-described table by using operators in the candidate operator set to obtain the set of metalanguage of the to-be-described table.

Alternatively, referring to FIG. 13, the apparatus further includes:

a table acquiring module 1301, configured to acquire sample tables and sets of sample metalanguage of the sample tables;

a table type determining submodule 1302, configured to perform type analysis on the to-be-described table by using a pre-trained extractor, to determine whether the pre-trained extractor supports a table type of the to-be-described table;

a metalanguage extraction submodule 1303, configured to, if yes, select a candidate operator set from operators of the extractor, and perform metalanguage extraction on the to-be-described table by using operators in the candidate operator set to obtain the set of metalanguage of the to-be-described table;

a text generating module 1304, configured to generate the description text of the to-be-described table based on the first type of metalanguage and the second type of metalanguage;

an error message output submodule 1305, configured to, if not, output an error message indicating that the table type of the to-be-described table is not supported.

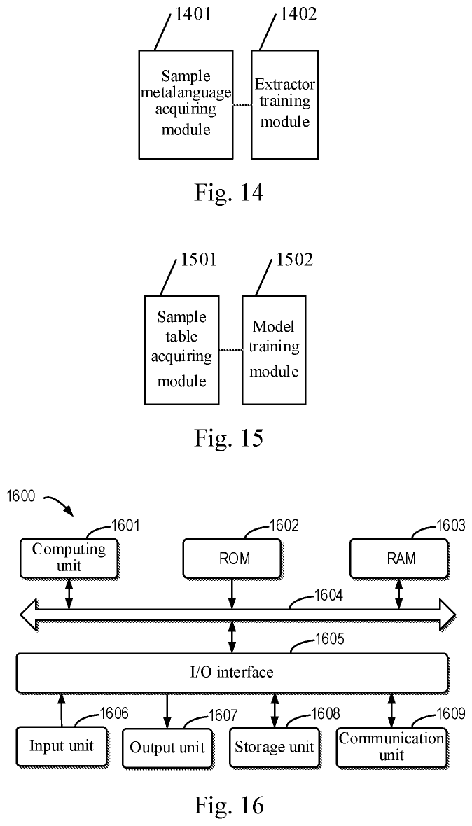

Alternatively, referring to FIG. 14, the apparatus further includes:

a sample metalanguage acquiring module 1401, configured to acquire sample tables and sets of sample metalanguage of the sample tables; and

an extractor training module 1402, configured to train an extractor by using the sample tables and the sets of sample metalanguage of the sample tables to obtain a pre-trained extractor.

Alternatively, referring to FIG. 15, the apparatus further includes:

a sample table acquiring module 1501, configured to acquire sample tables and description texts of the sample tables; and

a model training module 1502, configured to joint-train an extractor, the content organization model, and the text generation model by using the sample tables and the description texts of the sample tables to obtain a pre-trained extractor, the pre-trained content organization model, and the pre-trained text generation model.

It can be seen that, through the apparatus for generating a table description text, the to-be-described table may be acquired, and by using a pre-trained extractor, the to-be-described table may be analyzed to obtain a set of metalanguage of the to-be-described table, and finally a description text of the to-be-described table may be generated based on the metalanguage in the set of metalanguage. Therefore, automatic generation of the table description text is realized, not only a labor cost may be reduced, but also the time-consuming of generating the table description text may be reduced, and the efficiency of generating the table description text may be improved.

According to embodiments of the present disclosure, an electronic device, a readable storage medium, and a computer program product are also provided.

FIG. 16 illustrates a schematic block diagram of an example electronic device 1600 for implementing embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 16, the device 1600 includes a computing unit 1601, which may perform various appropriate actions and processing, based on a computer program stored in a read-only memory (ROM) 1602 or a computer program loaded from a storage unit 1608 into a random access memory (RAM) 1603. In the RAM 1603, various programs and data required for the operation of the device 1600 may also be stored. The computing unit 1601, the ROM 1602, and the RAM 1603 are connected to each other through a bus 1604. An input/output (I/O) interface 1605 is also connected to the bus 1604.

A plurality of parts in the device 1600 are connected to the I/O interface 1605, including: an input unit 1606, for example, a keyboard and a mouse; an output unit 1607, for example, various types of displays and speakers; the storage unit 1608, for example, a disk and an optical disk; and a communication unit 1609, for example, a network card, a modem, or a wireless communication transceiver. The communication unit 1609 allows the device 1600 to exchange information/data with other devices over a computer network such as the Internet and/or various telecommunication networks.

The computing unit 1601 may be various general-purpose and/or dedicated processing components having processing and computing capabilities. Some examples of the computing unit 1601 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 1601 performs the various methods and processes described above, such as the method for generating a table description text. For example, in some embodiments, the method for generating a table description text may be implemented as a computer software program, which is tangibly included in a machine readable medium, such as the storage unit 1608. In some embodiments, part or all of the computer program may be loaded and/or installed on the device 1600 via the ROM 1602 and/or the communication unit 1609. When the computer program is loaded into the RAM 1603 and executed by the computing unit 1601, one or more steps of the method for generating a table description text described above may be performed. Alternatively, in other embodiments, the computing unit 1601 may be configured to perform the method for generating a table description text by any other appropriate means (for example, by means of firmware).

Various embodiments of the systems and technologies described in this article may be implemented in digital electronic circuit systems, integrated circuit systems, field programmable gate arrays (FPGA), application specific integrated circuits (ASIC), application-specific standard products (ASSP), system-on-chip (SOC), complex programmable logic device (CPLD), computer hardware, firmware, software, and/or their combinations. These various embodiments may include: being implemented in one or more computer programs, the one or more computer programs may be executed and/or interpreted on a programmable system including at least one programmable processor, the programmable processor may be a dedicated or general-purpose programmable processor that may receive data and instructions from a storage system, at least one input apparatus, and at least one output apparatus, and transmit the data and instructions to the storage system, the at least one input apparatus, and the at least one output apparatus.

Program codes for implementing the method of the present disclosure may be written in any combination of one or more programming languages. The above program codes may be encapsulated into computer program products. These program codes or computer program products may be provided to a processor or controller of a general purpose computer, special purpose computer or other programmable data processing apparatus such that the program codes, when executed by the processor 901, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with a user, the systems and technologies described herein may be implemented on a computer, the computer has: a display apparatus (e.g., CRT (cathode ray tube) or LCD (liquid crystal display) monitor for displaying information to the user; and a keyboard and a pointing apparatus (for example, a mouse or trackball), the user may use the keyboard and the pointing apparatus to provide input to the computer. Other kinds of apparatuses may also be used to provide interaction with the user; for example, the feedback provided to the user may be any form of sensory feedback (for example, visual feedback, auditory feedback, or tactile feedback); and may use any form (including acoustic input, voice input, or tactile input) to receive input from the user.

The systems and technologies described herein may be implemented in a computing system (e.g., as a data server) that includes back-end components, or a computing system (e.g., an application server) that includes middleware components, or a computing system (for example, a user computer with a graphical user interface or a web browser, through which the user may interact with the embodiments of the systems and technologies described herein) that includes front-end components, or a computing system that includes any combination of such back-end components, middleware components, or front-end components. The components of the system may be interconnected by any form or medium of digital data communication (e.g., a communication network). Examples of the communication network include: local area network (LAN), wide area network (WAN), and Internet.

The computer system may include a client and a server. The client and the server are generally far from each other and usually interact through a communication network. The client and server relationship is generated by computer programs operating on the corresponding computer and having client-server relationship with each other. The server may be a cloud server, also known as a cloud computing server or a cloud host, which is a host product in a cloud computing service system and may solve the defects of difficult management and weak service scalability existing in a conventional physical host and a VPS (Virtual Private Server) service.

It should be understood that various forms of processes shown above may be used to reorder, add, or delete steps. For example, the steps described in embodiments of the present disclosure may be performed in parallel, sequentially, or in different orders, as long as the desired results of the technical solution disclosed in embodiments of the present disclosure can be achieved, no limitation is made herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A method for generating a table description text, the method comprising:
acquiring a to-be-described table;
analyzing the to-be-described table to obtain a set of metalanguage of the to-be-described table, wherein the set of metalanguage comprises at least one metalanguage, and the metalanguage is a word and sentence determined according to a cell in the to-be-described table; and
generating a description text of the to-be-described table based on the metalanguage in the set of metalanguage.

2. The method according to claim 1, wherein the set of metalanguage comprises a first type of metalanguage and a second type of metalanguage, the first type of metalanguage is a word and sentence representing semantics of the cell in the to-be-described table, and the second type of metalanguage is a word and sentence representing an association relationship between at least two pieces of metalanguage of the first type; and
the generating the description text of the to-be-described table based on the metalanguage in the set of metalanguage, comprises:
generating the description text of the to-be-described table based on the first type of metalanguage and the second type of metalanguage.

3. The method according to claim 2, wherein the generating the description text of the to-be-described table based on the first type of metalanguage and the second type of metalanguage, comprises:
filtering and sorting the first type of metalanguage and the second type of metalanguage in the set of metalanguage by using a pre-trained content organization model, to obtain content organization plan data; and
inputting the content organization plan data into a pre-trained text generation model to obtain the description text of the to-be-described table.

4. The method according to claim 3, wherein the filtering and sorting the first type of metalanguage and the second type of metalanguage in the set of metalanguage by using the pre-trained content organization model to obtain the content organization plan data, comprises:
acquiring a data graph of the to-be-described table;
filtering, based on the data graph, the first type of metalanguage and the second type of metalanguage in the set of metalanguage by using the pre-trained content organization model, to obtain a set of filtered metalanguage; and
sorting, based on the data graph, the first type of metalanguage and the second type of metalanguage in the set of filtered metalanguage by using the pre-trained content organization model, to obtain the content organization plan data.

5. The method according to claim 1, wherein the analyzing the to-be-described table to obtain the set of metalanguage of the to-be-described table, comprises:
performing type analysis on the to-be-described table by using a pre-trained extractor; and
in response determining that the pre-trained extractor supports a table type of the to-be-described table, selecting a candidate operator set from operators of the extractor, and performing metalanguage extraction on the to-be-described table by using operators in the candidate operator set, to obtain the set of metalanguage of the to-be-described table.

6. The method according to claim 5, wherein, after the performing type analysis on the to-be-described table, the method further comprises:
in response determining that the pre-trained extractor does not support the table type of the to-be-described table, outputting an error message indicating that the table type of the to-be-described table is not supported.

7. The method according to claim 1, wherein the method further comprises:
acquiring sample tables and sets of sample metalanguage of the sample tables; and
training an extractor by using the sample tables and the sets of sample metalanguage of the sample tables to obtain a pre-trained extractor.

8. The method according to claim 3, wherein the method further comprises:
acquiring sample tables and description texts of the sample tables; and
joint-training an extractor, the content organization model, and the text generation model by using the sample tables and the description texts of the sample tables, to obtain a pre-trained extractor, the pre-trained content organization model, and the pre-trained text generation model.

9. An apparatus for generating a table description text, the apparatus comprising:
at least one processor; and
a memory communicatively connected to the at least one processor; wherein,
the memory stores instructions executable by the at least one processor, and the instructions, when executed by the at least one processor, cause the at least one processor to perform operations, the operations comprising:
acquiring a to-be-described table;
analyzing the to-be-described table to obtain a set of metalanguage of the to-be-described table, wherein the set of metalanguage comprises at least one metalanguage, and the metalanguage is a word and sentence determined according to a cell in the to-be-described table; and
generating a description text of the to-be-described table based on the metalanguage in the set of metalanguage.

10. The apparatus according to claim 9, wherein the set of metalanguage comprises a first type of metalanguage and a second type of metalanguage, the first type of metalanguage is a word and sentence representing semantics of the cell in the to-be-described table, and the second type of metalanguage is words and sentence representing an association relationship between at least two pieces of metalanguage of the first type; and
the generating the description text of the to-be-described table based on the metalanguage in the set of metalanguage, comprises:
generating the description text of the to-be-described table based on the first type of metalanguage and the second type of metalanguage.

11. The apparatus according to claim 10, wherein the generating the description text of the to-be-described table based on the first type of metalanguage and the second type of metalanguage, comprises:
filtering and sorting the first type of metalanguage and the second type of metalanguage in the set of metalanguage by using a pre-trained content organization model, to obtain content organization plan data; and
inputting the content organization plan data into a pre-trained text generation model to obtain the description text of the to-be-described table.

12. The apparatus according to claim 11, wherein the filtering and sorting the first type of metalanguage and the second type of metalanguage in the set of metalanguage by using the pre-trained content organization model to obtain the content organization plan data, comprises:
acquiring a data graph of the to-be-described table;
filtering, based on the data graph, the first type of metalanguage and the second type of metalanguage in the set of metalanguage by using the pre-trained content organization model, to obtain a set of filtered metalanguage; and
sorting, based on the data graph, the first type of metalanguage and the second type of metalanguage in the set of filtered metalanguage by using the pre-trained content organization model, to obtain the content organization plan data.

13. The apparatus according to claim 9, wherein the analyzing the to-be-described table to obtain the set of metalanguage of the to-be-described table, comprises:
performing type analysis on the to-be-described table by using a pre-trained extractor; and
in response determining that the pre-trained extractor supports a table type of the to-be-described table, selecting a candidate operator set from operators of the extractor, and performing metalanguage extraction on the to-be-described table by using operators in the candidate operator set to obtain the set of metalanguage of the to-be-described table.

14. The apparatus according to claim 13, wherein the operations further comprise:
in response determining that the pre-trained extractor does not support a table type of the to-be-described table, outputting an error message indicating that the table type of the to-be-described table is not supported.

15. The apparatus according to claim 9, wherein the operations further comprise:
acquiring sample tables and sets of sample metalanguage of the sample tables; and
training an extractor by using the sample tables and the sets of sample metalanguage of the sample tables to obtain a pre-trained extractor.

16. The apparatus according to claim 11, wherein the operations further comprise:
acquiring sample tables and description texts of the sample tables; and
joint-training an extractor, the content organization model, and the text generation model by using the sample tables and the description texts of the sample tables to obtain a pre-trained extractor, the pre-trained content organization model, and the pre-trained text generation model.

17. A non-transitory computer readable storage medium storing computer instructions, wherein, the computer instructions, when executed by a computer, cause the computer to perform operations, the operations comprising:
acquiring a to-be-described table;
analyzing the to-be-described table to obtain a set of metalanguage of the to-be-described table, wherein the set of metalanguage comprises at least one metalanguage, and the metalanguage is a word and sentence determined according to a cell in the to-be-described table; and
generating a description text of the to-be-described table based on the metalanguage in the set of metalanguage.

18. The storage medium according to claim 17, wherein the set of metalanguage comprises a first type of metalanguage and a second type of metalanguage, the first type of metalanguage is a word and sentence representing semantics of the cell in the to-be-described table, and the second type of metalanguage is a word and sentence representing an association relationship between at least two pieces of metalanguage of the first type; and
the generating the description text of the to-be-described table based on the metalanguage in the set of metalanguage, comprises:
generating the description text of the to-be-described table based on the first type of metalanguage and the second type of metalanguage.

19. The storage medium according to claim 18, wherein the generating the description text of the to-be-described table based on the first type of metalanguage and the second type of metalanguage, comprises:
filtering and sorting the first type of metalanguage and the second type of metalanguage in the set of metalanguage by using a pre-trained content organization model, to obtain content organization plan data; and
inputting the content organization plan data into a pre-trained text generation model to obtain the description text of the to-be-described table.

20. The storage medium according to claim 19, wherein the filtering and sorting the first type of metalanguage and the second type of metalanguage in the set of metalanguage by using the pre-trained content organization model to obtain the content organization plan data, comprises:
acquiring a data graph of the to-be-described table;
filtering, based on the data graph, the first type of metalanguage and the second type of metalanguage in the set of metalanguage by using the pre-trained content organization model, to obtain a set of filtered metalanguage; and
sorting, based on the data graph, the first type of metalanguage and the second type of metalanguage in the set of filtered metalanguage by using the pre-trained content organization model, to obtain the content organization plan data.
